(19) United States
(12) Patent Application Publication
(10) Pub. No.: US 2014/0248946 A1
(43) Pub. Date: Sep. 4, 2014

(54) SPORTS COLLECTIBLES AND COMMODITIES GAME

(71) Applicants: BOBBIE JO SEARLS, Austin, TX (US); DAVID G. HALL, Coto de Caza, CA (US); JOHN C. NELSON, Laguna Beach, CA (US)

(72) Inventors: BOBBIE JO SEARLS, Austin, TX (US); DAVID G. HALL, Coto de Caza, CA (US); JOHN C. NELSON, Laguna Beach, CA (US)

(21) Appl. No.: 13/784,231

(22) Filed: Mar. 4, 2013

(51) Int. Cl. A63F 13/00

(52) U.S. Cl. CPC A63F 13/00
USPC 463/30

(57) ABSTRACT

A sports collectibles and commodities game is described that includes at least one generated image of a collectible item, wherein the generated image comprises an area that is strategically incomplete; and an interface that allows a player to describe, supplement or complete the image. Methods of playing a sports collectibles and commodities game are also disclosed that includes: connecting to the sports and commodities game through a website, webpage, application or “app”, social media interface or a combination thereof, selecting the player option, viewing at least one generated image of a collectible item, wherein the generated image comprises an area that is strategically incomplete; and using an interface that allows a player to describe, supplement or complete the image to provide at least one descriptive piece of information related to the generated image.

### FIELD OF THE SUBJECT MATTER

The field of the subject matter is sports collectibles and commodities games, methods and uses thereof.

### BACKGROUND

Online and networked games have never been more popular with consumers, including those allowing one or more players to be challenged by other players or to be challenged by the computer. Games generally can be broken down into three categories: entertainment-based, learning-based, and skill-based games. Most games combine each of these categories, but it can be said that a particular game may be primarily placed in one category, and overlap slightly with one or more of the other categories.

Sports fans and collectors have traditionally liked to collect sports trading cards, where their favorite players or players from their favorite teams are shown on the card. A player's card may come in several different forms or looks, because several different companies can design and produce a player's card. Therefore, an Albert Pujols card from Topps may look completely differently than an Albert Pujols card from Upper Deck. In addition, the Albert Pujols rookie card from Topps may look differently than the 2010 Albert Pujols card from Topps. Most serious collectors can spot these differences. In addition, most baseball fans can recite information and statistics about individual players. Much of this information can be found on the front or back of the trading cards.

Other collectible items and commodities are just as popular as sports trading cards in some collector communities. These collectible items include cars, motorcycles, art, sculpture and other collectible items. Commodities include rare or specialty coins, paper or synthetic currency and other commodities. Each of these items is unique and has several points of identification for someone who is interested in these items. In addition, most of these items have interesting histories, owners and trivia information associated with them.

To this end, it would be desirable to develop, produce and utilize a collectibles and commodities game having at least one of the following ideal properties: a) can be played with one player against a computer or multiple players against one another, b) can include identifying various points of distinction or information about a collectible or commodity item in order to advance in the game, c) can provide a scoring mechanism, d) can provide a timing mechanism, e) can be played in league format, f) can be played on a computer, smart phone, tablet or pad device, handheld device, or another suitable device that allows for game play, g) can provide additional information about the collectibles or commodities, h) can be used as a marketing tool for collectibles or commodities, and i) can be played by using multiple choice format for the answer or can be played by filling in blanks in the game.

### SUMMARY OF THE SUBJECT MATTER

A sports collectibles and commodities game is described that includes at least one generated image of a collectible item, wherein the generated image comprises an area that is strategically incomplete; and an interface that allows a player to describe, supplement or complete the image.

Methods of playing a sports collectibles and commodities game are also disclosed that includes: connecting to the sports collectibles and commodities game through a website, webpage, application or “app”, social media interface or a combination thereof, selecting the player option, viewing at least one generated image of a collectible item, wherein the generated image comprises an area that is strategically incomplete; and using an interface that allows a player to describe, supplement or complete the image to provide at least one descriptive piece of information related to the generated image.

In addition, methods of playing a sports collectibles and commodities game are disclosed that includes: connecting to the sports and commodities game through a website, webpage, application or “app”, social media interface or a combination thereof, selecting the player option, wherein there is at least two players, providing at least one generated image of a collectible item to another player, wherein the generated image comprises an area that is strategically incomplete.

### BRIEF DESCRIPTION OF THE FIGURES

FIG. 1 shows a contemplated schematic of a sports collectibles and other commodities game.

FIG. 2 shows a contemplated method for playing a sports collectibles and other commodities game from the standpoint of one player.

FIG. 3 shows a contemplated method for playing a sports collectibles and other commodities game from the standpoint of another player.

FIG. 4 shows an original sports card 410 (in this Figure in a case 415) and the game view card 420 is shown with the name 430 and autograph 440 of the player missing in the game 450.

The home page 510, as shown in FIG. 5, should have a top menu bar, a sub-head describing the game, ads and banner ads, social media links, company information and the ability to select the desired game 520 to play.

A new user (not shown) can join by clicking the 1) Join link, 2) one of the game selections, or 3) the Log In link 610, as shown in FIG. 6, on the user interface or webpage 600.

Once a user selects a game, he will be given the option 710 to play as a single user or challenge another player, as shown in FIG. 7, on the user interface or webpage 700.

As shown in FIG. 8, the user will have the option to play the game using the small size 810, a larger size which will retain the upper menu bar 820, or a full size (not shown) that will not retain the upper menu bar.

To start the game, the user will click on the “pitch” button 910, as shown in FIG. 9, on the user interface or webpage 900.

After “Pitch” is clicked a card 1010 will be “thrown” on the screen 1000, as shown in FIG. 10.

The user then clicks “Batter Up” 1110 to go back to the field, as shown in FIG. 11, on the user interface or webpage 1100.

With each hit, the cards 1210 move around the bases 1220, as shown in FIG. 12, on the user interface or webpage 1200.

In this example, the user “hit” a triple by correctly guessing Clemente, Fleer, 1963 1310. This sent his Ted Williams card 1320 home for a run. The scoreboard updates to reflect the score 1330, as shown in FIG. 13, on the user interface or webpage 1300.

After nine innings, the game ends, the play icons disappear and the scoreboard reflects the final score 1410, as shown in FIG. 14, on the user interface or webpage 1400.

If the user is not logged in, his own stats will not be viewable unless he qualifies for the Leader Board. The stats 1500 may be recorded as shown in FIG. 15.

To start the game, the user will click on the “pitch” button 1620 on the user interface 1600. The play continues for three innings with three strike outs per inning. This embodiment is shown in FIG. 16, where the scoreboard 1610 reflects only the single player.

After “Pitch” is clicked a card 1710 will be “thrown” on the screen 1700, as shown in FIG. 17.

If the user has correctly guessed the player's name, it will fill in the box 1810 and the next set of answer buttons 1820 will appear, as shown in FIG. 18, on the user interface 1800.

If any of the four questions are answered incorrectly, an X 1920 appears in the appropriate box 1910 (or graphically illustrated to indicate the answer is wrong), as shown in FIG. 19, on the user interface 1900.

At any time during a game after a card 2010 has been in play and all four questions 2020 have been revealed, the user can click 2030 on the card to see statistical information 2040 from PSA CardFacts. The user can click on the card prior to it fading from the screen or from any card that is on base, as shown on the user interface 2000 in FIG. 20.

After a few seconds the correct answers 2110 appear on the user interface 2100 and then the player's image and answers 2120 fade out. If there is a base hit, the player 2130 is placed on the base. With each hit, the cards move around the bases 2140, as shown in FIG. 21. The play resumes again be clicking “Pitch!”.

If the user fails to answer the player's name 2210 correctly on the user interface 2200, it will be a strike out. After a few seconds the player's image 2220 fades out, the correct answers appear, “OUT” 2230 appears on the screen 2200 and the out is listed on the scoreboard 2240, as shown in FIG. 22.

If a user wants to challenge a friend to top his score, he would click the “Challenge” button 2310 on the user interface 2300. His challenge and stats 2320 would be sent to the friend whose contact information he enters into the box 2330, as shown in FIG. 23.

### DETAILED DESCRIPTION

A collectibles and commodities game has been developed that has at least one of the following ideal properties: a) can be played with one player against a computer or multiple players against one another, b) includes identifying various points of distinction or information about a collectible or commodity item in order to advance in the game, c) provides a scoring mechanism, d) provides a timing mechanism, e) can be played in league format, f) can be played on a computer, smart phone, tablet or pad device, handheld device, or another suitable device that allows for game play, g) can provide additional information about the collectibles or commodities, h) can be used as a marketing tool for collectibles or commodities, and i) can be played by using multiple choice format for the answer or can be played by filling in blanks in the game.

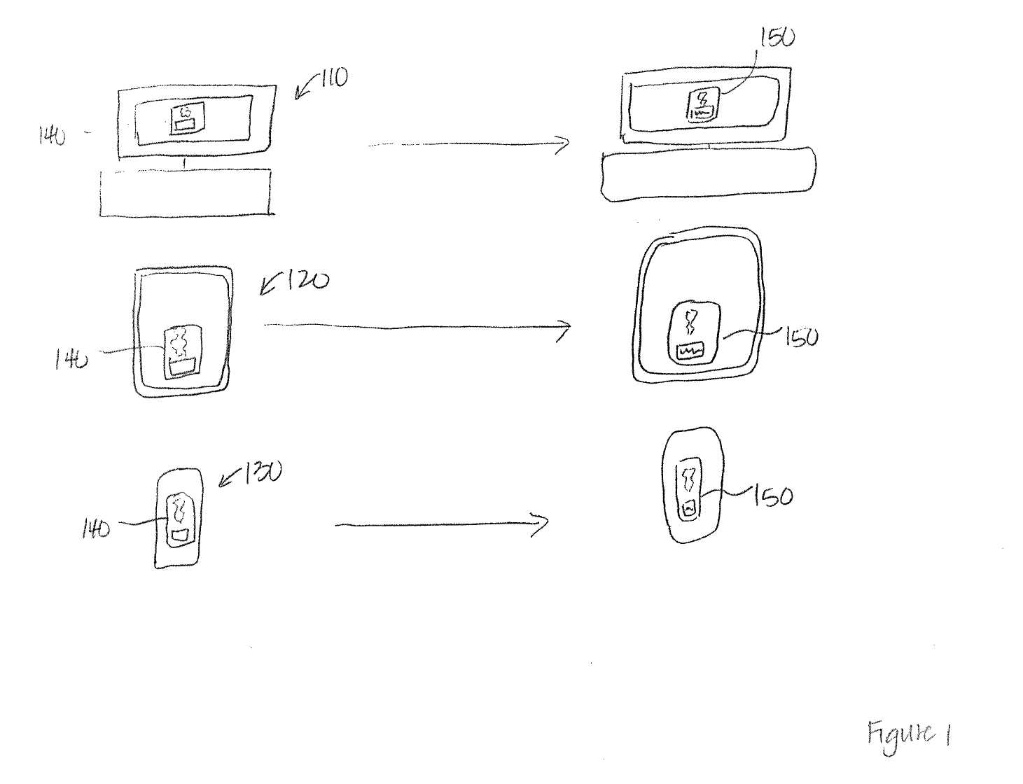

Specifically, a sports collectibles and commodities game is described that includes at least one generated image of a collectible item, wherein the generated image comprises an area that is strategically incomplete; and an interface that allows a player to describe, supplement or complete the image. In some contemplated embodiments, the interface comprises a keyboard, a touchscreen, a voice-activated system, a voice-digitalization system or a combination thereof. In some contemplated embodiments, a strategically incomplete image may be completed by using a multiple choice format, where the player is presented with several choices and picks one as a part of the game to complete the image. FIG. 1 shows a computer 110, a tablet 120 and a smart phone 130, whereby an incomplete generated image 140 is displayed and a completed generated image 150, according to game play is shown.

In some contemplated embodiments, the collectible item comprises a coin, a paper currency, a trading card, a motorized vehicle or a combination thereof. In a specific embodiment, the trading card comprises a sports trading card, such as a baseball trading card, a football trading card, a hockey trading card, a basketball trading card or another suitable sports trading card.

Contemplated sports collectibles and commodities games may comprise an accessible resource database that comprises completed information for the collectible items. This resource database may include interesting facts about the collectible items, trivia information about the collectible items, famous owners of the collectible items or a combination thereof. A contemplated resource database is designed to provide the information for the generated image, provide a check against the information that the player provides to describe, supplement or complete the image, provide additional information to the player or players to supplement the game or a combination thereof.

Contemplated interfaces may comprise an interactive component, wherein the interactive component operatively allows more than one player to actively participate in the game. In some embodiments, a player may play the game against the computer, against a friend, against a random person or persons who are selected by the computer, in a league or a combination thereof. In other contemplated embodiments, the interactive component comprises at least one social media login component, at least one social media sharing component or a combination thereof.

In some embodiments, contemplated sports collectibles and commodities games comprise a timing mechanism that is coupled to the generated image. It is contemplated that timing mechanisms, as described herein, comprise at least one timed event. Contemplated timing mechanisms may use any suitable timing method or counting procedure, including counting seconds or counting minutes. In some embodiments, the at least one timed event comprises a repeating countdown. As described, the each timed event may comprise a period of time, such as 30 seconds. The player is given 30 seconds to complete, describe or supplement at least one descriptive feature of the generated image. At the end of the timed event, another timed event may start giving the player more time.

In some embodiments, contemplated sports collectibles and commodities games may comprise a scoring system. In contemplated embodiments, the scoring system is operatively coupled with the timing mechanism. In some embodiments, the scoring system is operatively coupled with the timing mechanism, the image component or a combination thereof. In these embodiments, the player's ability to complete at least one image component in a certain period of time improves the player's score, the ability of the player to move forward or advance in the game, or a combination thereof. As contemplated herein, the scoring system comprises scoring points, earning currency, advancing around a series of bases, gaining at least one yard or a combination thereof.

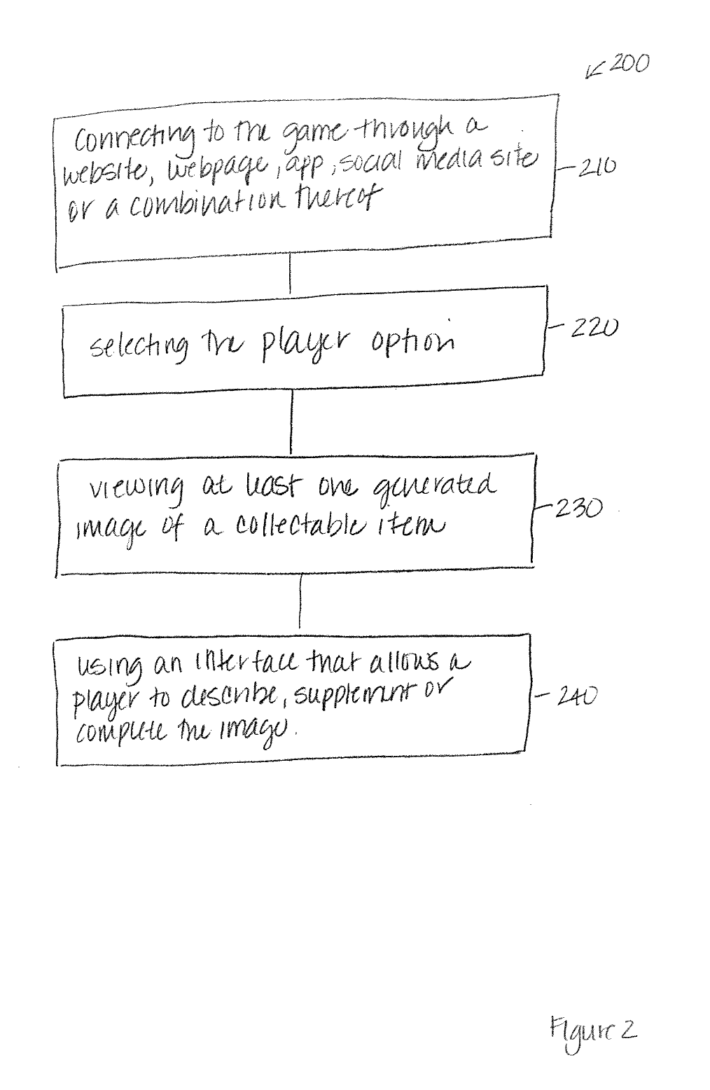

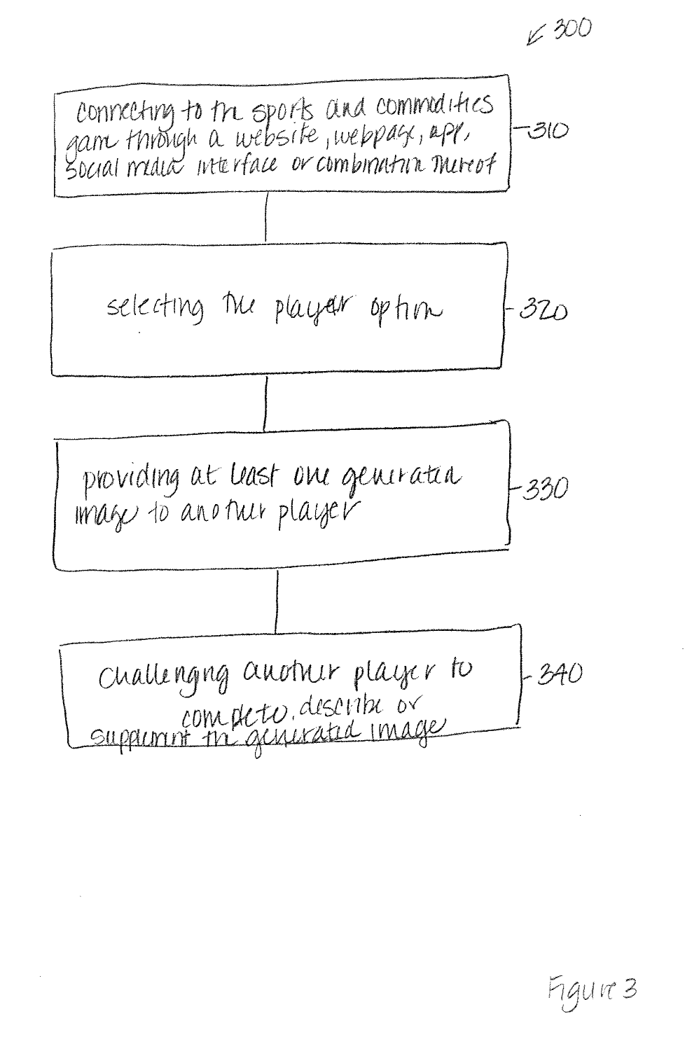

Methods of playing a sports collectibles and commodities game 200 are shown in FIG. 2 and include: connecting 210 to the sports and commodities game through a website, webpage, application or “app”, social media interface or a combination thereof, selecting 220 the player option, viewing 230 at least one generated image of a collectible item, wherein the generated image comprises an area that is strategically incomplete; and using 240 an interface that allows a player to describe, supplement or complete the image to provide at least one descriptive piece of information related to the generated image. In this method, the player is the one who is operatively playing the game by being challenged to complete, describe or supplement the generated image. In a sports analogy, the player in this method is like a batter in a baseball game.

In addition, methods of playing a sports collectibles and commodities game 300 are shown in FIG. 3 and include: connecting 310 to the sports and commodities game through a website, webpage, application or “app”, social media interface or a combination thereof, selecting 320 the player option, wherein there is at least two players, providing 330 at least one generated image of a collectible item to another player, wherein the generated image comprises an area that is strategically incomplete. In this method, the player is the one who is operatively playing the game by challenging 340 another player to complete, describe or supplement the generated image. In a sports analogy, the player in this method is like a pitcher in a baseball game.

### Example

### Game: Sports Trading Cards with Baseball Format—Option 1

### Object of the Game

This contemplated embodiment is a baseball card game which scores on the user's ability to correctly name baseball cards. Users compete on a game by game basis and accumulate statistics over a period of time which, if top in a category, will result in sponsored prizes, leader board recognition or other forms of award.

### Playing the Game

### One Player (User)

The “pitcher” (the software program) throws up an image of a baseball card with everything but the image of the baseball player hidden. To score, the user must correctly guess enough cards to move his baseball cards around the bases. When a card moves to fourth base (home plate} a run is scored. For an inning to continue, a user must not have three strike outs. Strike outs would occur when the user has not correctly guessed the player featured on the baseball card. Three strikes and the play goes to the next inning. There are nine innings and at the end of the ninth inning, the user's stats are calculated.

### Two Players (Users)

The game is played with the rules stated above, but each inning allows two users to play. When one user has three strike outs, the second user plays. When both users have played, the next inning begins, if the game is tied at the end of the 9th inning, the game is extended until one user scores a run.

### Scoring the Game

The user must guess the name of the player on the baseball card flashed on the screen to get a hit to first base. A double is a correct guess of the player and manufacturer (company name) of the card. A triple is a correct guess of the player, manufacturer and year. A home run is a correct guess of the player, manufacturer, year, and card number. If there is no card number, then the user must enter “none” to be correct. If the user misses the player's name, but gets one of the other fields correct, then it is a foul ball and he has a second chance to answer the player's name. If the user misses again, it is a pop out. For single user games, when three strike outs occur, a new inning begins. The end of the ninth inning marks the end of the game. For two user games, each user plays once during an inning. At the end of the ninth inning, the winner is the user with most runs. Statistics are calculated for all users. When a game is over, if the stats of the current game top a user's past single game stats, they are recorded as his personal best. Season and lifetime averages are also calculated. Individual user's stats are placed in other users' stats.

### Programming the Game

Code developed for this game will be written as an engine so that it can drive other sports cards games such as basketball, football and hockey and guess-the autograph game. Code will also be converted to applications such as iphone, ipd, ipod and android. HTML5 is the recommended language as it is easily transferrable among platforms.

### PSA Content

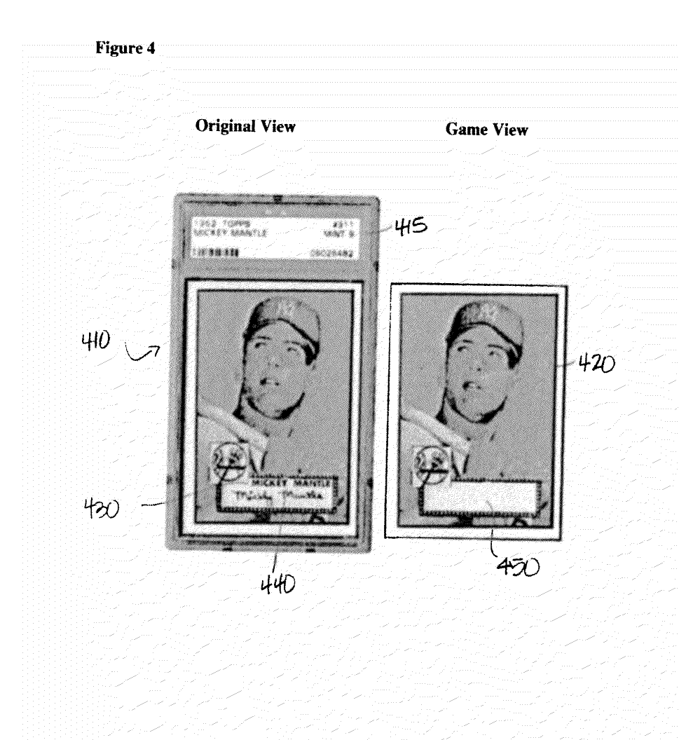

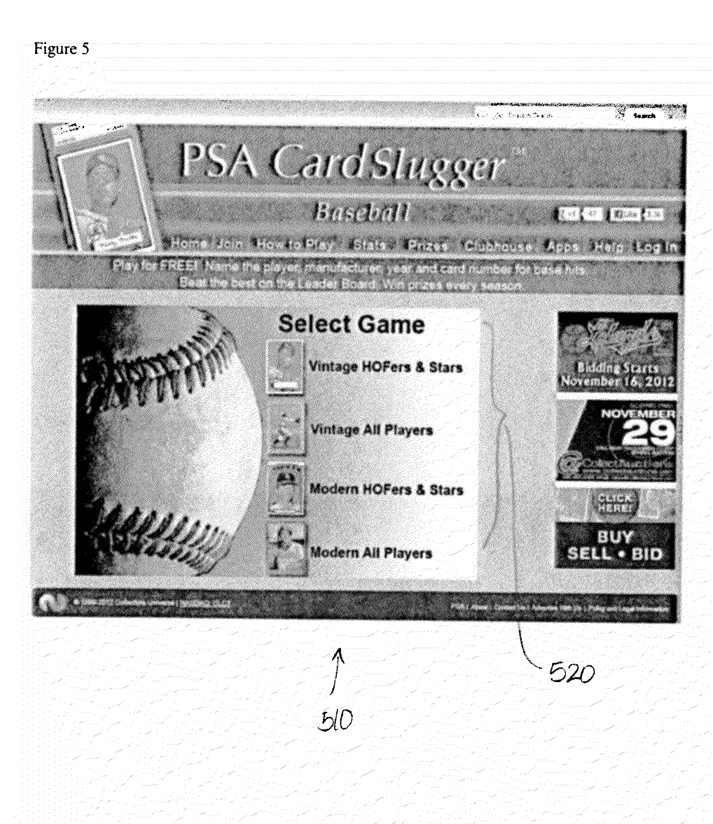

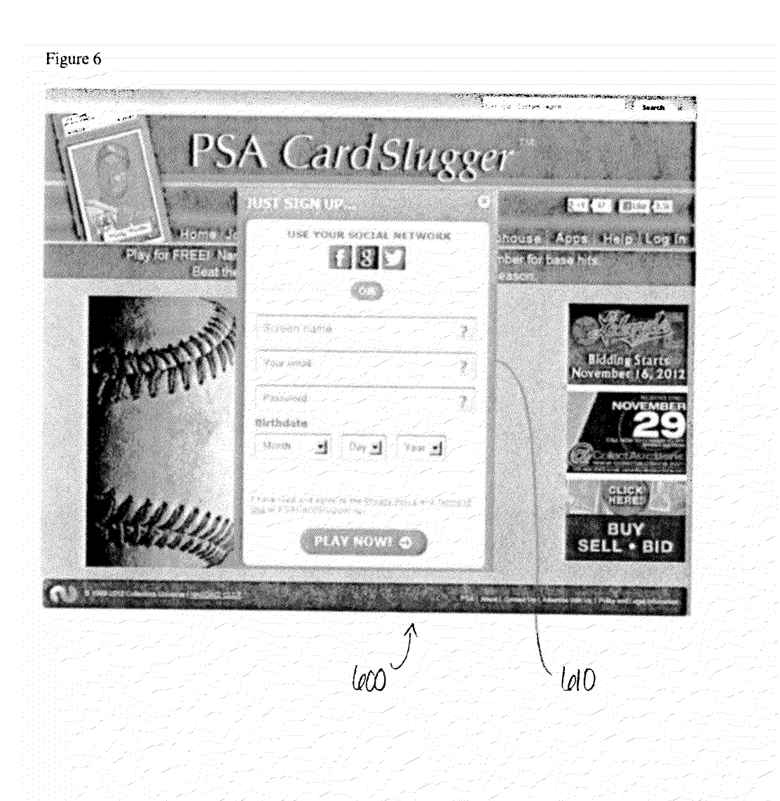

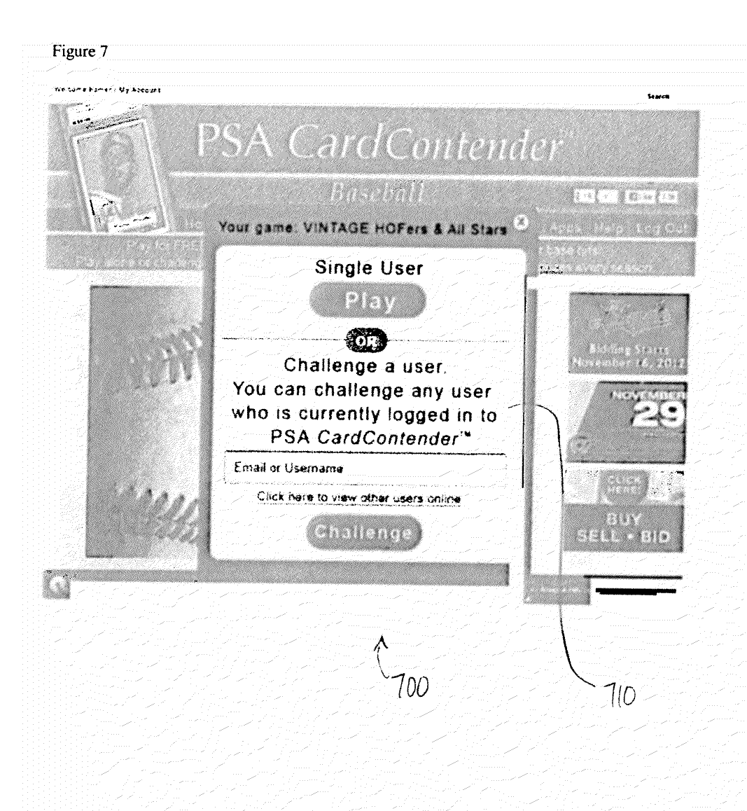

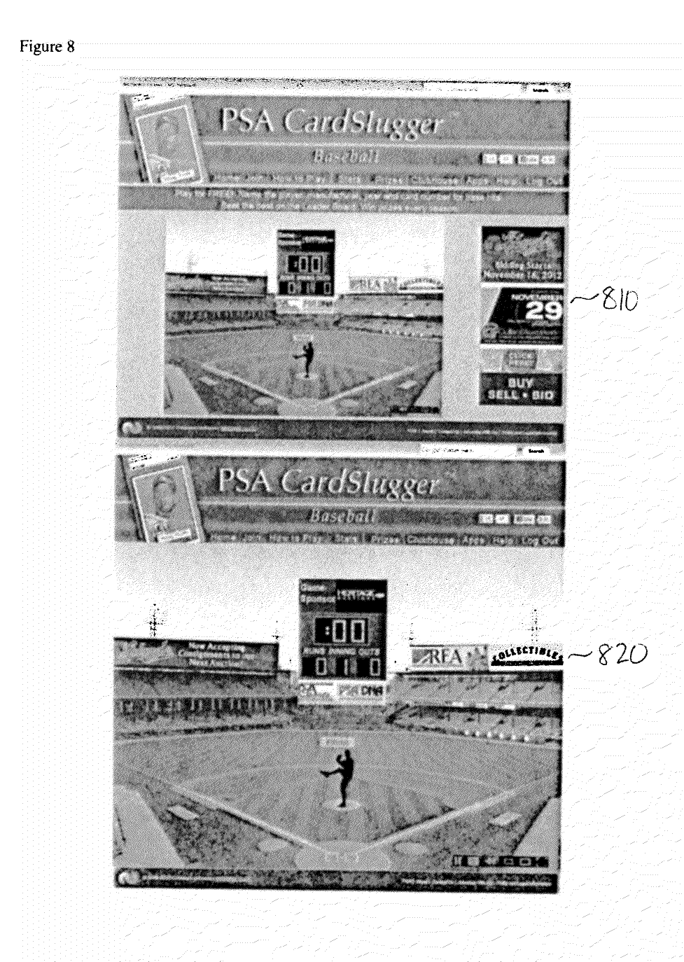

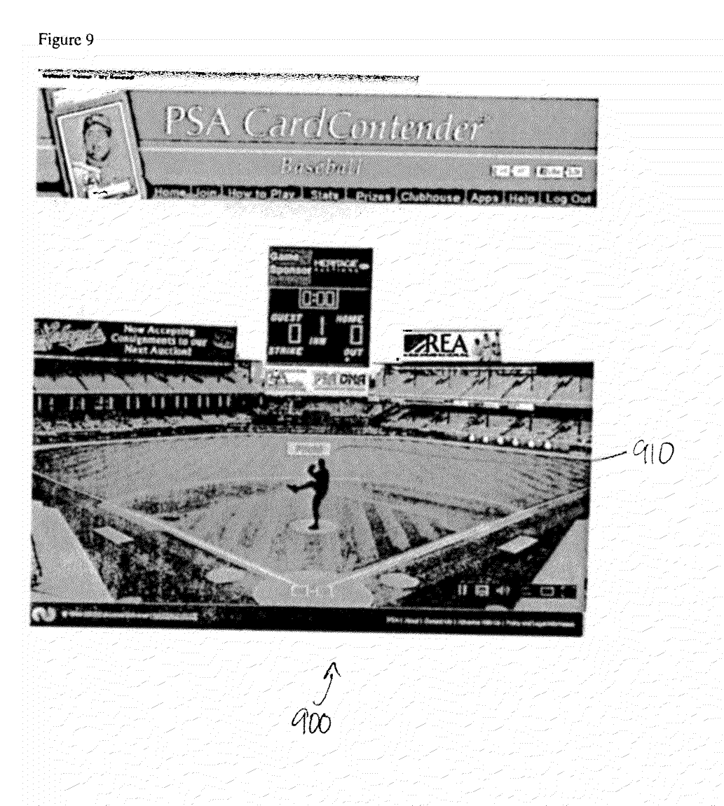

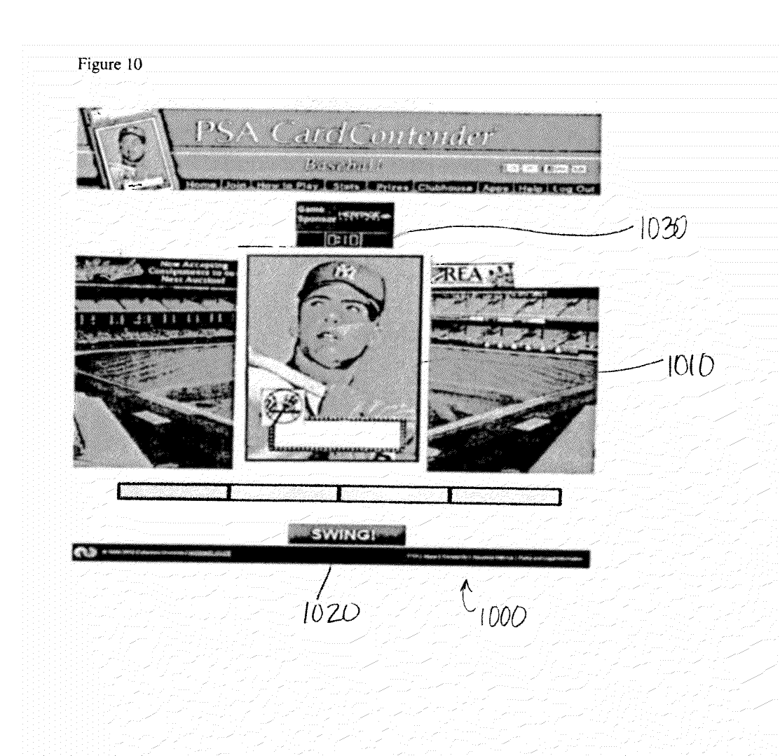

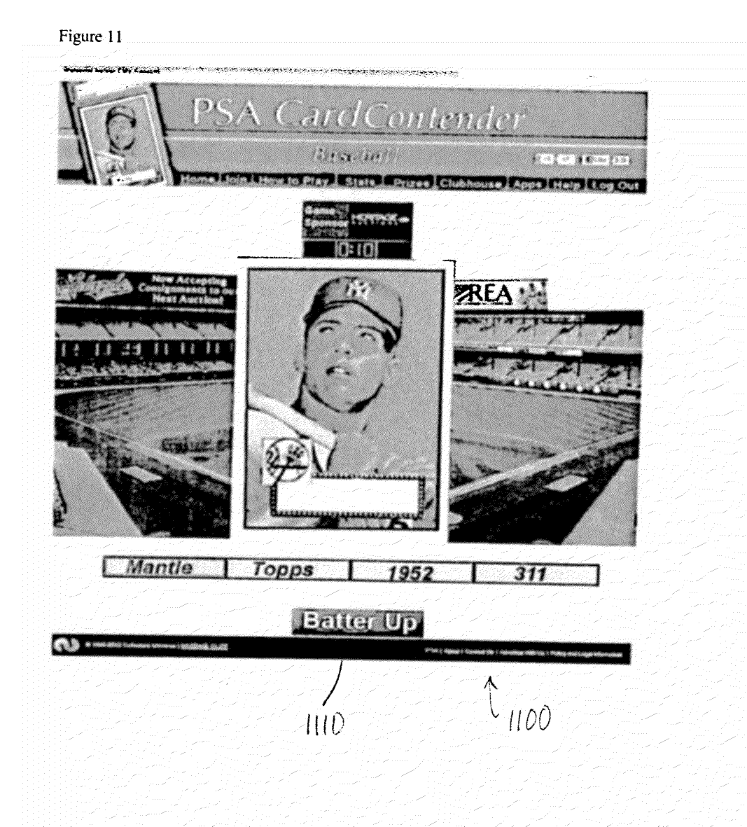

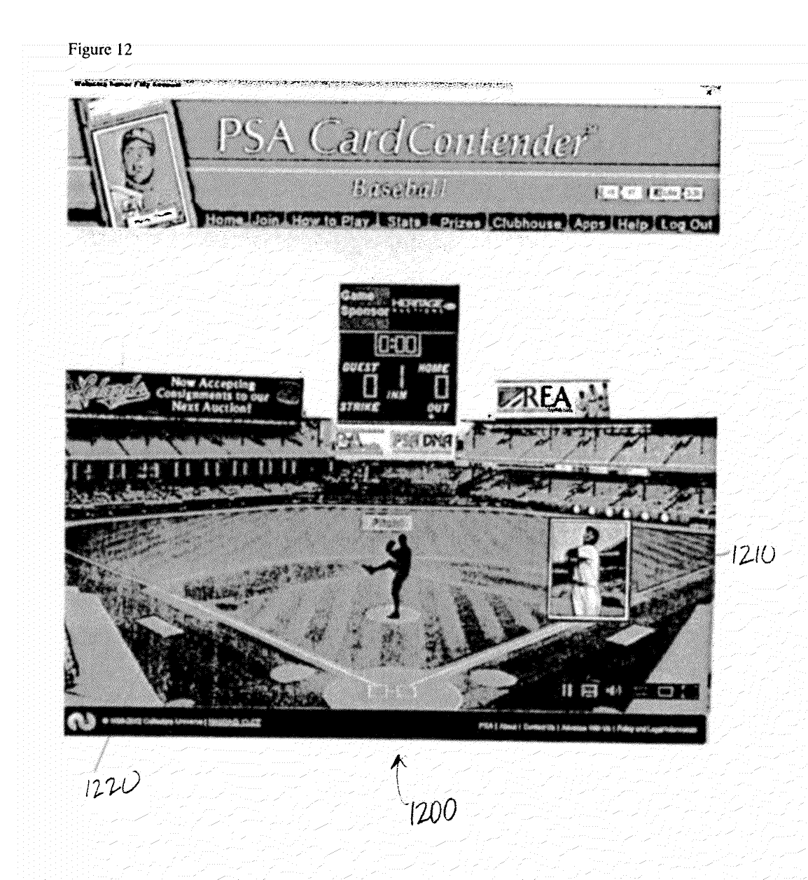

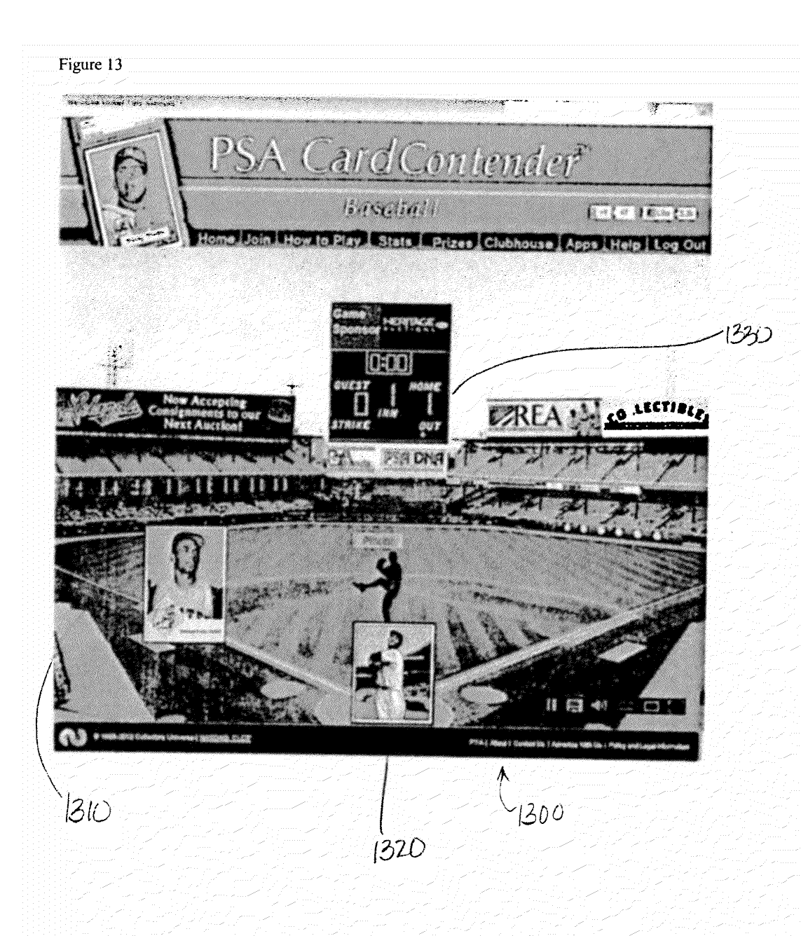

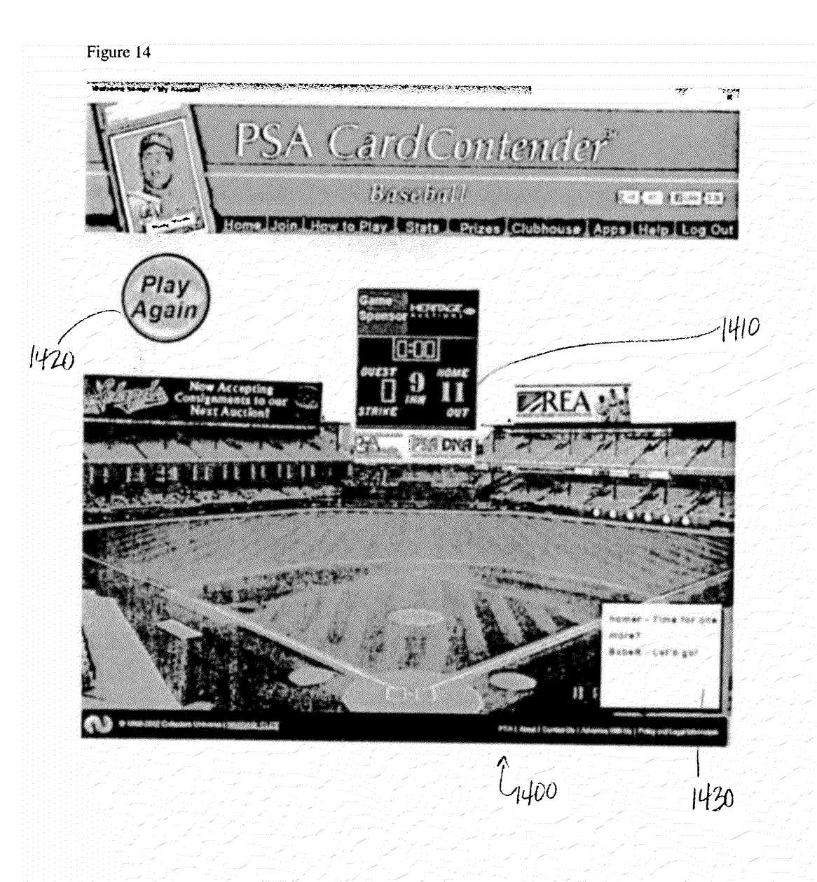

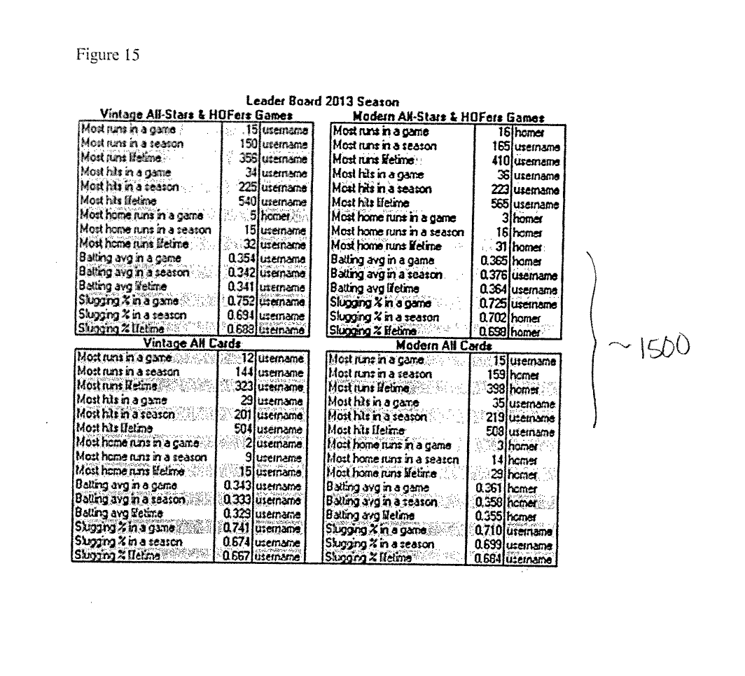

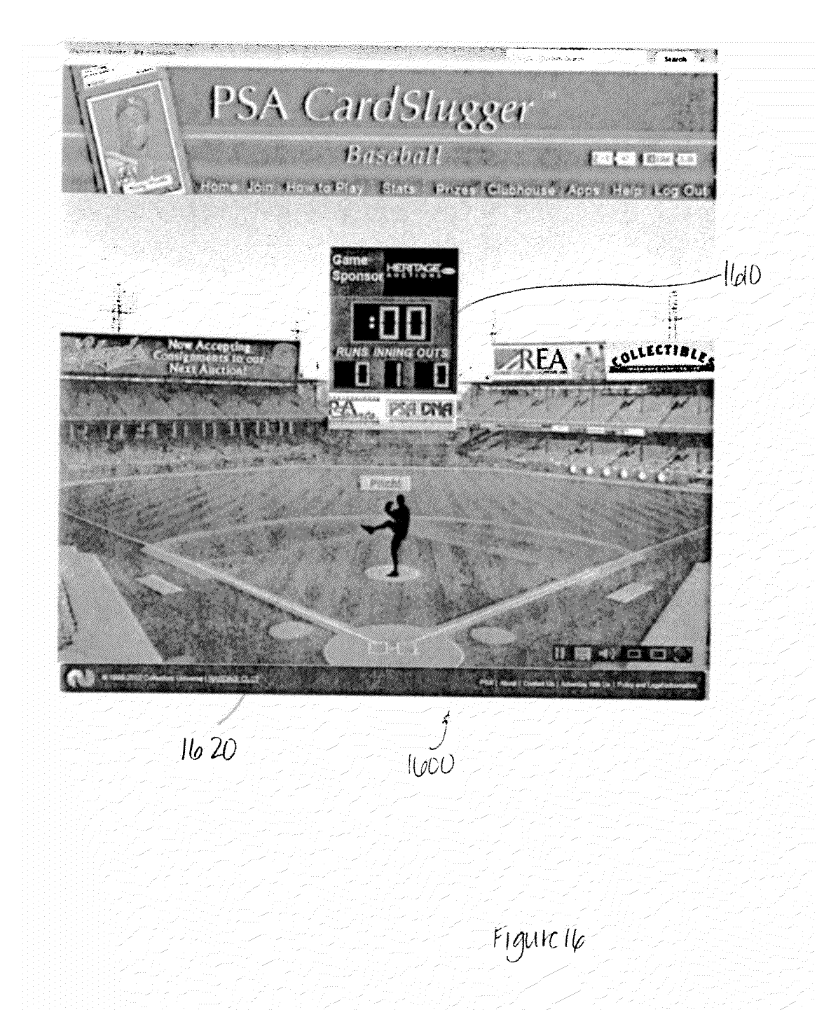

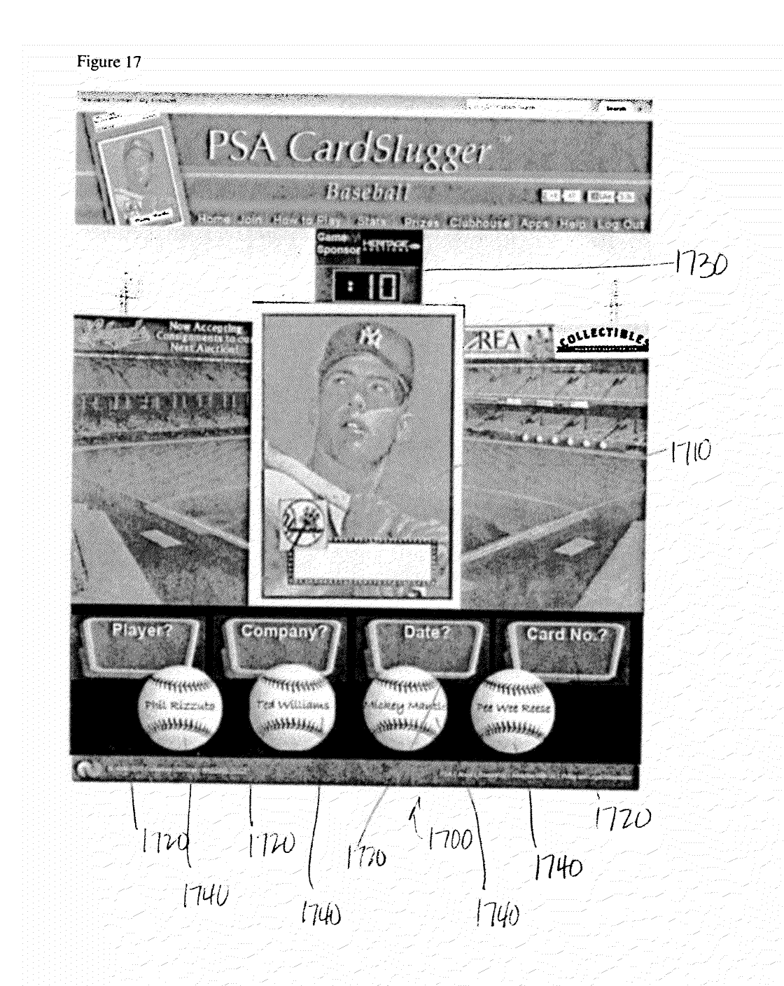

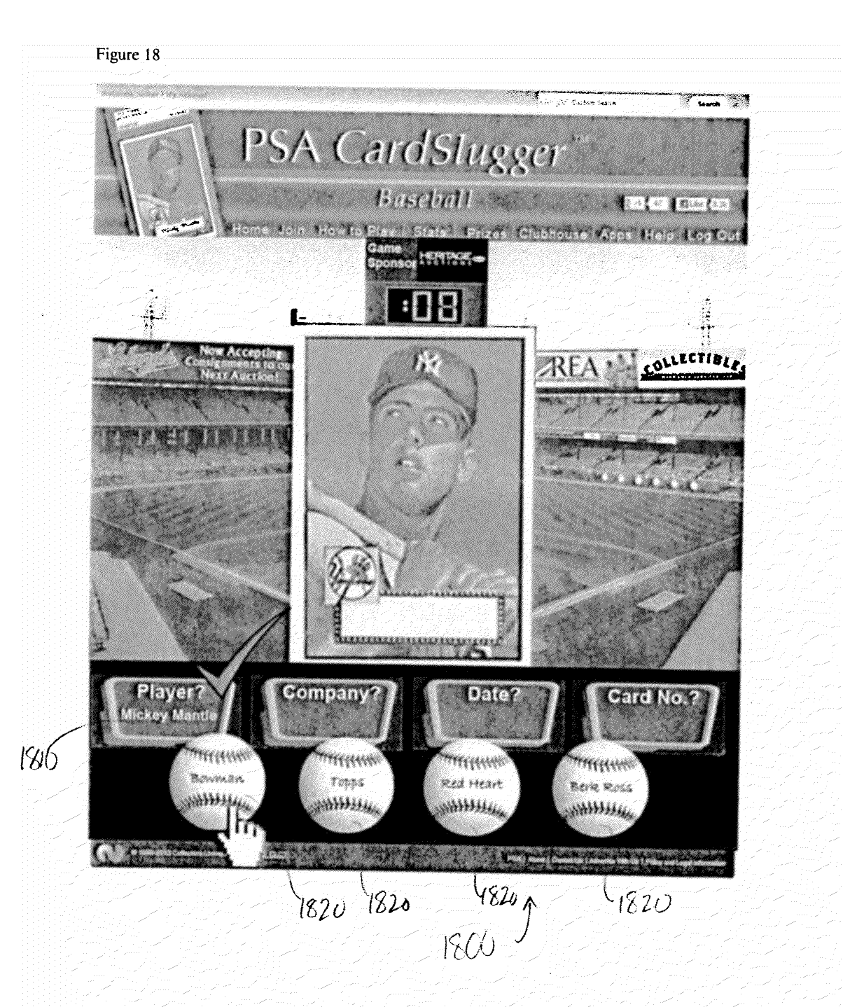

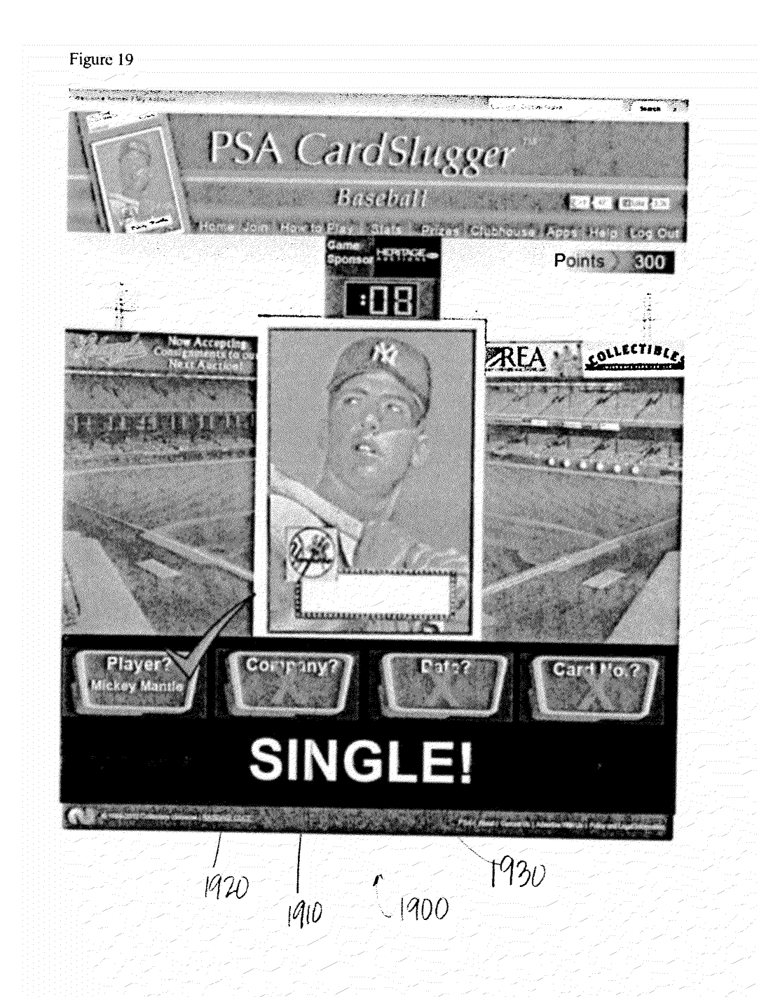

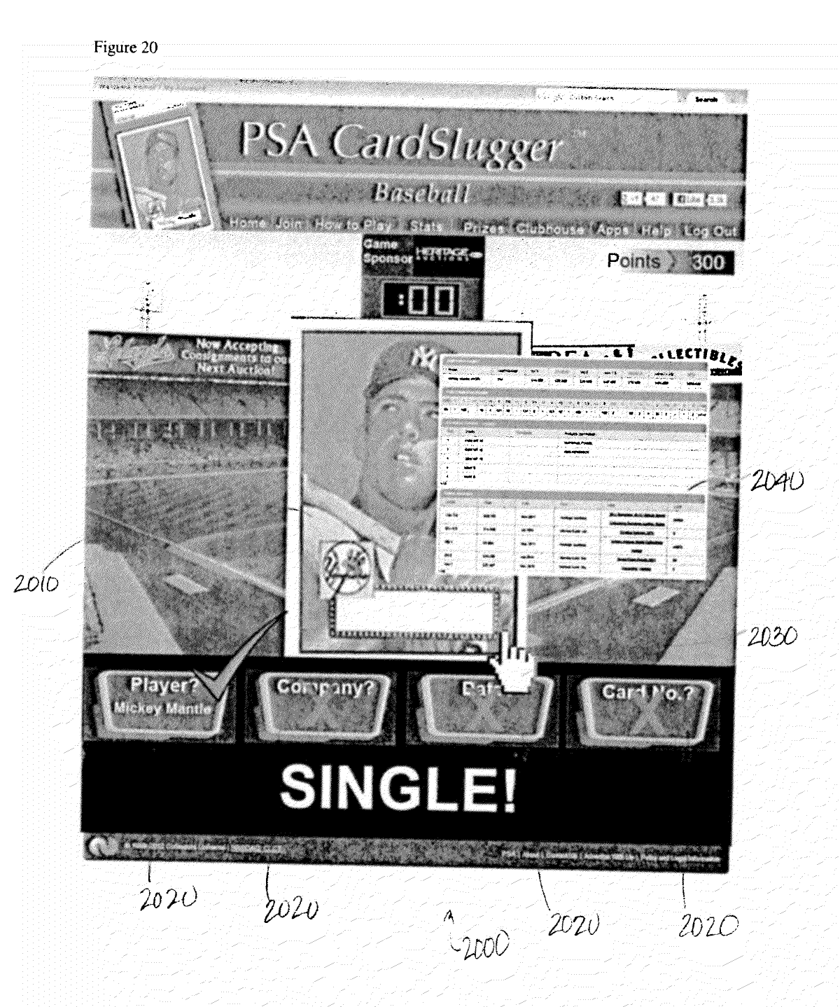

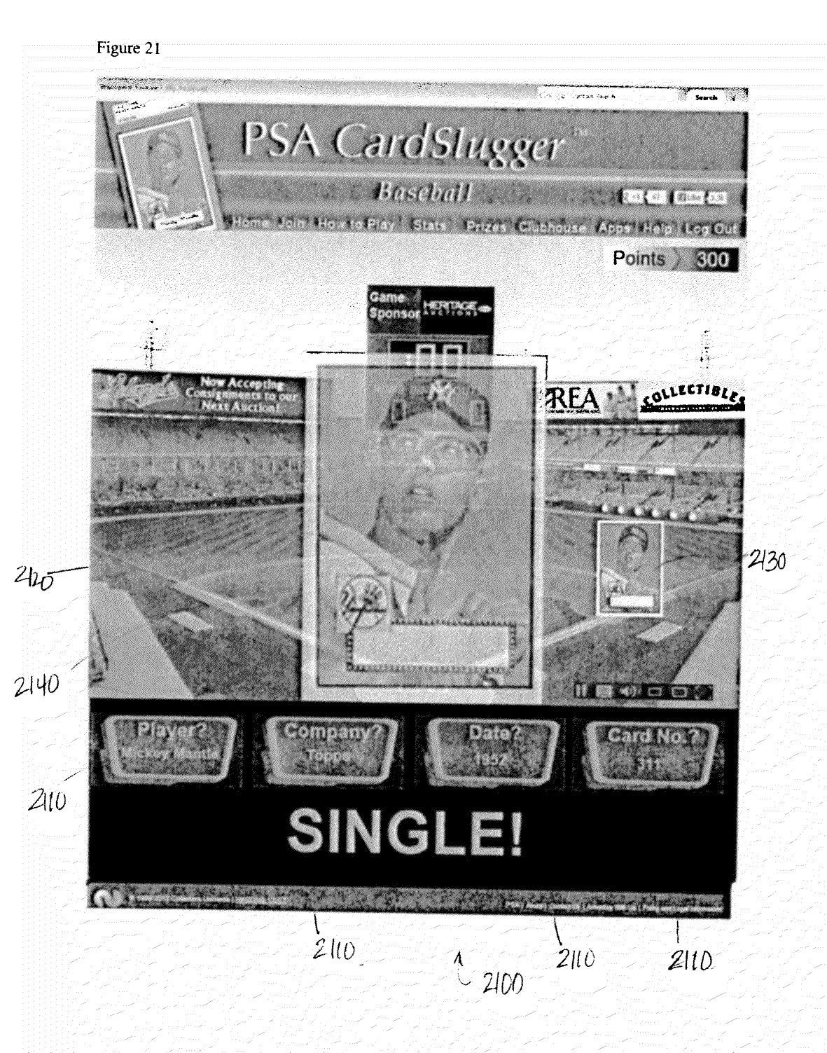

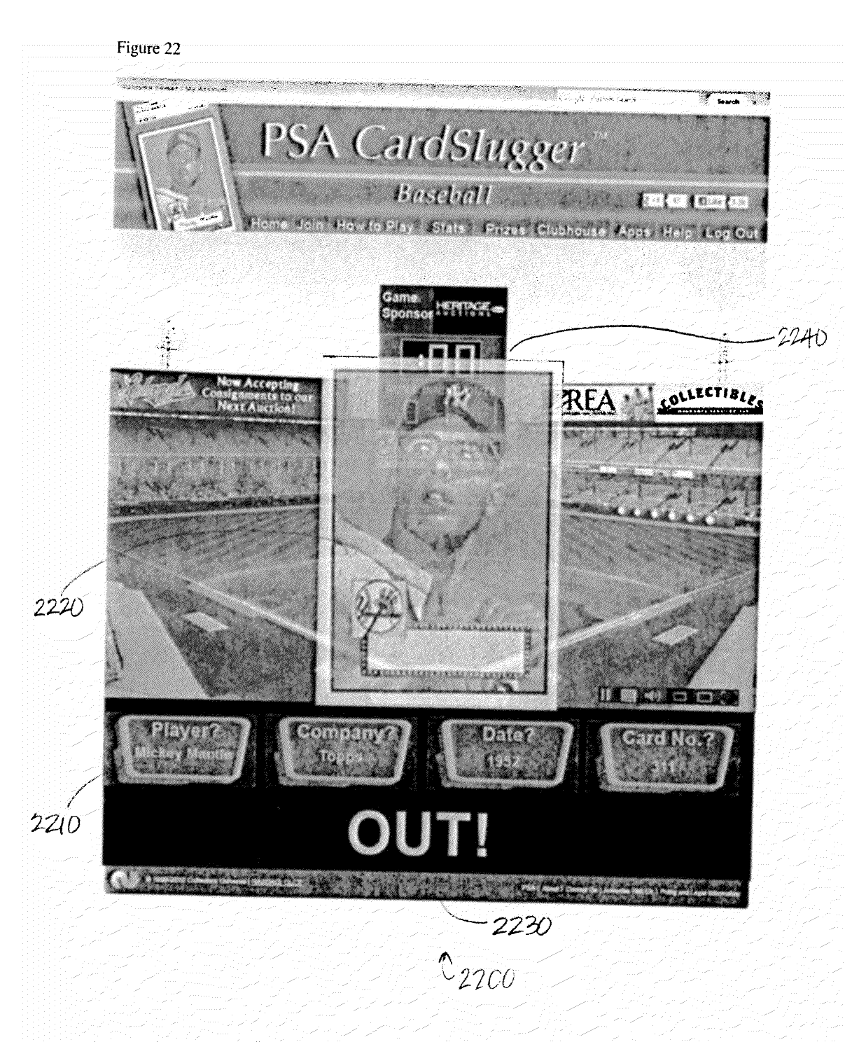

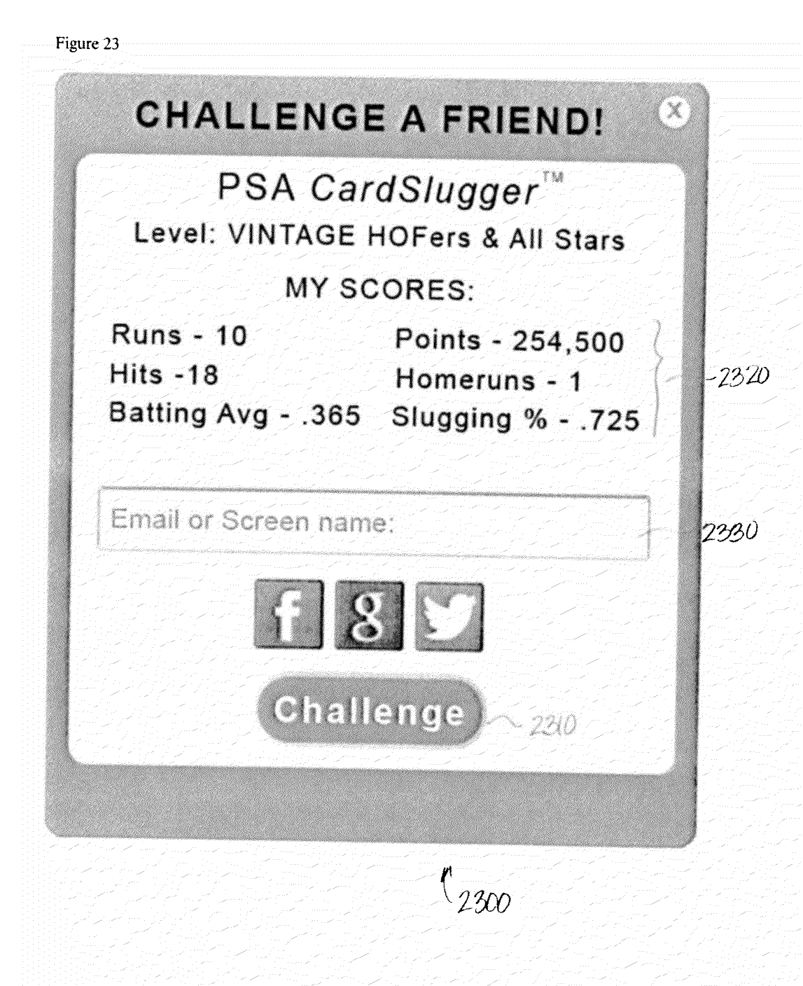

Images will be copied from the PSA CardFacts database into the PSA CardContender database. Currently there are over 22,000 images. Each card image will have the card player name, date, manufacturer and card number removed. An Example is shown in FIG. 4 where an original sports card 410 is shown (in this Figure in a case 415) and the game view card 420 is shown with the name 430 and autograph 440 of the player missing in the game 450.

During development, an entry level Photoshop worker will be contracted to update the cards so that at launch the entire CardFacts inventory will be ready for CardContender. After launch, a report will be generated to the game manager so that as new images are uploaded to PSA CardFacts these can be updated and added to the CardContender database. A coded file name will be established for the game cards so that they can be easily located in the game database.

There will be two game options with two levels of play within each game:
Vintage Cards (Pre-1970)
   Level 1—Stars & HOFers
   Level 2—All Cards
Modern Cards (1970-Present)
   Level 1—Stars & HOFers
   Level 2—All Cards
      The PSA CardContender database will be separated into four categories so the game selected by the user will determine which cards will be used.

The game software will recognize the user each time he plays so that a new card is displayed each time the user swings. This will continue until all cards in the database within the category selected have been played. Cards will be displayed in random order within the category.

### Game Graphics

The game should be rendered in 3-D animation with sound (music, bat cracking, crowd cheering, etc.) The playing field should simulate a baseball field with infield, outfield, bases and scoreboard. The home page 510, as shown in FIG. 5, should have a top menu bar, a sub-head describing the game, ads and banner ads, social media links, company information and the ability to select the desired game 520 to play.

### Join

A new user (not shown) can join by clicking the 1) Join link, 2) one of the game selections, or 3) the Log In link 610, as shown in FIG. 6, on the user interface or webpage 600. 1) If he has used the Join link, he will be brought back to the home page to select a game after he joins. 2) If he selects a game first, he will see the login popup which will refer him to the Join pop-up. After he joins he will be taken directly to the game selected. 3) If a new user clicks the Log In link, the log in pop-up will appear which refers him Join link and brings the new user to the sign up page. After he joins he will be brought back to the home page to select a game.

### Member Log In

Current members can log in two ways: 1) Click the Log In link. 2) Click the “Playin button on a selected game. If the user has remained logged in, he will go directly to the selected game. If he is not logged in the pop-up log in screen will appear after which the user will be taken directly to the game selected.

### Single User or Two-User Options

Once a user selects a game, he will be given the option 710 to play as a single user or challenge another player, as shown in FIG. 7, on the user interface or webpage 700. If he does not have specific challenger in mind, he can view a list of users who are currently online by using the link “Click here to view other users online” which will display other users currently logged in. He can invite a user to play by typing in another user's username (or clicking the username which will automatically fill in the box). If the invited user accepts the challenge, he can then save his current game to start play with the challenger. Saved games can be accessed by a link from the home page. Instant messaging (IM) will be available so that the two users can communicate.

### Loading the Game

After the user selects either single user play or play with a challenger, the game begins.

### Game Screen Sizes

As shown in FIG. 8, the user will have the option to play the game using the small size 810, a larger size which will retain the upper menu bar 820, or a full size (not shown) that will not retain the upper menu bar. The user can pause or save the game and also turn the sound off.

### Game Play

To start the game, the user will click on the “pitch” button 910, as shown in FIG. 9, on the user interface or webpage 900. Single users will play as the home team. The play continues for nine innings with three strike outs per inning. For a two-player game, the user who challenged another user will be the home team. The second user will always bat first as the guest team. Each user plays when the other user has three strike outs.

After “Pitch” is clicked a card 1010 will be “thrown” on the screen 1000, as shown in FIG. 10. The player's last name must be correctly answered for a hit by typing in the answer and clicking the “Swing” box 1020. (A correct first and last name answer will also be accepted.) The user has 10 seconds 1030 to guess the player's last name for a base hit, the player's last name & company for a double, the player's last name, company name & manufactured date for a triple, and the player's last name, company name, manufactured date & card number for a homerun. The clock on the scoreboard will count down. There will be no save or pause buttons once the clock is counting down. Note that the time could be increased, but must be somewhat limited to prevent the user from cheating.

If either company, manufactured date, or card number are correctly guessed but not the player's last name, it is a foul ball and considered a strike. The correct information will remain in the entry box. The user has another 10 seconds to enter the player's name by clicking the Swing button 1020.

If the user fails to enter a name or enters an incorrect name during the 10 seconds, the correct card information is displayed. The user then clicks “Batter Up” 1110 to go back to the field, as shown in FIG. 11, on the user interface or webpage 1100.

The user begins again by clicking the “Pitch” button for his second batter up, as shown in FIG. 10.

As the user makes a hit, a small icon of the card will be placed on the base. In this case the user correctly guessed “Williams” for the Ted Williams card. This icon will be linked to PSA CardFacts. If the user clicks icon to visit PSA CardFacts, the game is automatically paused until the user returns to the game. With each hit, the cards 1210 move around the bases 1220, as shown in FIG. 12, on the user interface or webpage 1200.

The number of bases a card moves depends on how many correct answers per card the user guesses. In this example, the user “hit” a triple by correctly guessing Clemente, Fleer, 1963 1310. This sent his Ted Williams card 1320 home for a run. The scoreboard updates to reflect the score 1330, as shown in FIG. 13, on the user interface or webpage 1300.

After nine innings, the game ends, the play icons disappear and the scoreboard reflects the final score 1410, as shown in FIG. 14, on the user interface or webpage 1400. The Users' stats are updated. If the user wants to play the same game again, he would select “Play Again” 1420. If two users are playing, they can have a rematch by selecting “Play Again.” If the user was playing Vintage Stars & HOFers and wants to play a different game, i.e. Vintage All Cards, Modern Stars & HOFers, or Modern All Cards, he would go Home and select another game. A text or instant message function box 1430 may also be integrated into the game, so that the players can talk to or message one another.

### Stats

Stats are linked from the menu bar will display the Leader Board for all users by their usernames. Stats will determine who wins sponsored prizes. Guessing a player's name in 10 seconds might be easy. Hitting a home run in 10 seconds may be quite difficult. Therefore, the size of the prize will be determined by difficulty. For example, “Most home runs in a game” might be a bigger prize than “Most runs in a game.” Also, “Most home runs in a game” in the Vintage All Cards category, might be a bigger prize than in Vintage Stars and HOFers.

The following stats may be recorded:
Most runs in a game
Most runs in a season
Most runs lifetime
Most hits in a season
Most hits lifetime
Most home runs in a game
Most home runs in a season
Most home runs lifetime
Batting avg in a game (the total number of hits divided by the total number of At Bats)
Batting avg in a season
Batting avg lifetime
Slugging % in a game ((1B)+(2×3B)+(4×HR)) divided by number of At Bats
Slugging % in a season
Slugging % lifetime

If the user is not logged in, his own stats will not be viewable unless he qualifies for the Leader Board. The stats 1500 may be recorded as shown in FIG. 15.

### Additional Contemplated Menu Pages:

### How to Play

### Prizes—Sponsorships & Banner Ads

Clubhouse—user forum
Apps—downloads for iphone, ipad, ipod & androit platforms

### Help

Game: Sports Trading Cards with Baseball Format—Option 2

### Object of the Game

This is a baseball card game which scores on the user's ability to correctly name baseball players and their baseball cards. Users compete on a game by game basis and accumulate statistics over a period of time which, if top in a category, will result in leader board recognition.

### Playing the Game

The “pitcher” (the software program or game code) throws up an image of a baseball card with everything but the image of the baseball player hidden. To score, a user must correctly guess enough cards to move his baseball cards around the bases. When a card moves to fourth base (home plate) a run is scored. For an inning to continue, a user must not have three strike outs. Strike outs would occur when the user has not correctly guessed the player featured on the baseball card. Three strike outs and the play will go to the next inning. There are three innings and at the end of the third inning, the user's stats are calculated.

### Scoring the Game

### Hits and Runs

The user must guess the name of the player on the baseball card flashed on the screen to get a hit to first base. A double is a correct guess of the player's name and either the manufacturer (company name), the manufacturer date, or the card number. A double advances the batter and all runners two bases. A triple is a correct guess of the player's name and two other correct answers. A triple advances the batter and all runners three bases. A home run is a correct guess of the player's name, manufacturer, year, and card number. The batter and all runners (if any) score on a home run. If the bases are full and the user gets a home run, it is a grand slam giving the user four runs. The end of the third inning marks the end of the game. Statistics are calculated for the user's game. When a game is over, if the stats of the current game top a user's past single game stats, they are recorded as his personal best. Season and lifetime averages are also calculated. Individual user's stats are placed in competition with other users' stats on the leader board.

### Points

During the game, points are awarded based on times, hits, and runs. As the user gets points, they are displayed during the game and then calculated on the leader board.
User gets a base hit and gets 100 points for every second remaining on the scoreboard.
User gets a double and he gets 1,000 points for every second remaining on the scoreboard.
User gets a triple and he gets 1,500 points for every second remaining on the scoreboard.
User gets a homerun and he gets 2,000 points for every second remaining on the scoreboard.

### Bonus Points

Base Hits=100
2 Base Hits in a row=100×2
3 Base Hits in a row=100×3
etc
Double=1000
2 Doubles in a row=1000×2
3 Doubles in a row=1000×3
etc
Triple=1500
2 Triples in a row=1500×2
3 Triples in a row=1500×3
etc
Home run=2000
2 Home runs in a row=2000×2
3 Home runs in a row=2000×3
etc
Grand Slam=2000×10
Runs=10000 per
   The following gives an example of how a can user can score points:

| | | | | | | Running |
|---|---|---|---|---|---|---|
| Play | | | Points | Multiplier | Sub Total | Total |
| Base hit in | 1 man on | 5 seconds left | 100 | 5 | 500 | 500 |
| 5 seconds | | on the clock | | | | |
| Base hit | | | 100 | 1 | 100 | 600 |
| bonus | | | | | | |
| Base hit in | 2 men on | 4 seconds left | 100 | 4 | 400 | 1,000 |
| 6 seconds | | on the clock | | | | |
| 2 Base hits | | | 100 | 2 | 200 | 1,200 |
| in a row | | | | | | |
| bonus | | | | | | |
| Out | 1 out | | — | | — | 1,200 |
| Base hit in | 3 men on | 3 seconds left | 100 | 3 | 300 | 1,500 |
| 7 seconds | | on the clock | | | | |
| Base hit | | | 100 | 1 | 100 | 1,600 |
| bonus | | | | | | |
| Home run | 4 runs-no | 2 seconds left | 2,000 | 2 | 4,000 | 5,600 |
| in 8 | men on | on the clock | | | | |
| seconds | | | | | | |
| Home run | | | 2,000 | 1 | 2,000 | 7,600 |
| bonus | | | | | | |
| Grand | | | 2,000 | 10 | 20,000 | 27,600 |
| slam | | | | | | |
| bonus | | | | | | |
| Runs | 4 runs | | 10,000 | 4 | 40,000 | 67,600 |
| bonus | | | | | | |
| Out | 2 outs | | — | | — | 67,600 |
| Double in | 1 man on | 5 seconds left | 1,000 | 5 | 5,000 | 72,600 |
| 5 seconds | | on the clock | | | | |
| Double | | | 1,000 | 1 | 1,000 | 73,600 |
| bonus | | | | | | |
| Double in | 2 men on | 1 second left | 1,000 | 1 | 1,000 | 74,600 |
| 9 seconds | | on the clock | | | | |
| 2 Doubles | | | 1,000 | 2 | 2,000 | 76,600 |
| in a row | | | | | | |
| bonus | | | | | | |
| Triple in 6 | 2 runs-1 | 4 seconds left | 1,500 | 4 | 6,000 | 82,600 |
| seconds | man on | on the clock | | | | |
| Triple | | | 1,500 | 1 | 1,500 | 84,100 |
| bonus | | | | | | |
| Runs | 2 runs | | 10,000 | 2 | 20,000 | 104,100 |
| bonus | | | | | | |
| Base hit in | 2 men on | 6 seconds left | 100 | 6 | 600 | 104,700 |
| 4 seconds | | on the clock | | | | |
| Base hit | | | 100 | 1 | 100 | 104,800 |
| bonus | | | | | | |
| Out | 3 outs | | — | | | 104,800 |

### Programming the Game

This game design document calls for the development of the game and webpages which will host the game. The webpages should maintain the look and feel of the current site at www.psacard.com. Code should be developed using standard object oriented programming concepts to facilitate use in future games for other sports. For example, for a football game, the quarterback will “throw” the card and the user would guess the player's name, manufacturer, date of manufacture, and card number to advance 10 yards or more. Correctly guessing all four questions will result in a touchdown.

For PC and Mac, the game needs to be tested for all browser platforms. Flash or HTML5 are the preferred platforms. If Flash is the developer's choice, then iOS development should follow up soon after the initial release for PC and Mac.

### PSA Content

Images can be copied from the PSA CardFacts database into the PSA CardSlugger database. Currently, there are over 22,000 images. Each card image will have the card player name, manufacturer, date, and card number removed.

During development the cards will be updated so that—at launch—the entire CardFacts inventory will be ready for CardSlugger. After launch, a report will be generated to the game manager so that as new images are uploaded to PSA CardFacts, these can be updated and added to the CardSlugger database. A coded file name will be established for the game cards so that they can be easily located in the game database.

There will be two game options with two levels of play within each game:
Vintage Cards (Pre-1970)
   Level 1—HOFers & Stars
   Level 2—All Cards
Modern Cards (1970-Present)
   Level 1—HOFers & Stars
   Level 2—All Cards

The PSA CardSlugger database will be separated into four categories so the game selected by the user will determine which cards will be used. Note that HOFers and stars will be included in both the “HOFers and Stars” and “All Players” categories.

The game software will recognize the user each time he plays so that a new card is displayed each time the user swings. This will continue until all cards in the database within the category selected have been played. Cards will be displayed in random order within the category.

### Game Graphics

The game can be rendered in 3-D animation with sound (music, bat cracking, crowd cheering, etc.) The playing field should simulate a baseball field with infield, outfield, bases & scoreboard. (Note: All graphics displayed in this game design document are for conceptualization only.) The home page should have a top menu bar, a sub-head describing the game, banner ads, social media links, and the ability to select the desired game to play.

### Join

The game will be found at www.psacard.com/games. A new user can join in three ways: 1) click the Join link, 2) select one of the game options, or 3) click the Log In link. 1) If he has used the Join link, he will be brought back to the home page to select a game after he joins. 2) If he selects a game first, he will see the login popup which will refer him to the Join pop-up. After he joins he will be taken directly to the game selected. 3) If a new user clicks the Log In link, the log in pop-up will appear which refers him Join link and brings the new user to the sign up page. After he joins he will be brought back to the home page to select a game.

### Member Log In

Current members can log in two ways: 1) Click the Log In link. 2) Click the “Play” button on a selected game. If the user currently has a login at the PSA website, he will be able to use that login for the game. If the user has remained logged in, he will go directly to the selected game. If he is not logged in the pop-up log in screen will appear after which the user will be taken directly to the game selected.

### Loading the Game

After the user selects his level of play, a game sponsor ad will display with a button to start the game. If the user is a member of the PSA Collectors Club, he will have no ad interruptions. Initially, only static banner ads will be displayed. These ads can easily be closed by clicking the play button. As the game gains popularity, 10-20 second interstitial video advertisements will be offered.

The game will default load in small size, however, the user will have the option to play the game using a larger size which will retain the upper menu bar. The user can pause or save the game when he is not guessing a player. He can also turn the sound off.

### Game Play

To start the game, the user will click on the “pitch” button 1620 on the user interface 1600. The play continues for three innings with three strike outs per inning. This embodiment is shown in FIG. 16, where the scoreboard 1610 reflects only the single player.

After “Pitch” is clicked a card 1710 will be “thrown” on the screen 1700, as shown in FIG. 17. There will be a series of four questions 1720 that begin with the player's name and must be answered within 10 seconds 1730. The scoreboard 1730 will provide the countdown. While a player is up to bat, the user will not be able to pause or save the game. The “wrong” answers will be pulled from cards within a four year period. So in other words, if the card is a 1952 Topps, wrong answers will be pulled from cards manufactured between 1950 and 1954. For card number “None” will always default as one of the four answers 1740.

In order to get a base hit, the player's name must be answered by clicking the button with the correct name. If the user correctly guesses the player's name & one other question, he gets a double. Correctly guessing the player's name and two other questions will result in a triple. A home run occurs when the player's name, manufacturer name, manufacturer date and the card number are all guessed correctly. If the user has correctly guessed the player's name, it will fill in the box 1810 and the next set of answer buttons 1820 will appear, as shown in FIG. 18, on the user interface 1800.

If any of the four questions are answered incorrectly, an X 1920 appears in the appropriate box 1910 (or graphically illustrated to indicate the answer is wrong), as shown in FIG. 19, on the user interface 1900. Additionally, if time runs out, the unanswered questions will be indicated by the X. If the user has had any base hits, Single, Double, Triple, or Home Run 1930 will be flashed on the screen. At the same time, if the user has scored points, those points will register on the screen. In this case, it took the user eight seconds to correctly guess the player's name with no other questions guessed correctly. The user would score 300 points for his base hit (100 points×2 seconds+100 bonus points).

At any time during a game after a card 2010 has been in play and all four questions 2020 have been revealed, the user can click 2030 on the card to see statistical information 2040 from PSA Card Facts. The user can click on the card prior to it fading from the screen or from any card that is on base, as shown on the user interface 2000 in FIG. 20.

After a few seconds the correct answers 2110 appear on the user interface 2100 and then the player's image and answers 2120 fade out. If there is a base hit, the player 2130 is placed on the base. With each hit, the cards move around the bases 2140, as shown in FIG. 21. The play resumes again be clicking “Pitch!”.

If the user fails to answer the player's name 2210 correctly on the user interface 2200, it will be a strike out. After a few seconds the player's image 2220 fades out, the correct answers appear, “OUT” 2230 appears on the screen 2200 and the out is listed on the scoreboard 2240, as shown in FIG. 22.

If the user correctly answers all four questions within 10 seconds, he has a home run and scores a run. In addition, he scores points based on his time to answer the questions. In this case he answered all four questions in 8 seconds. He scores 6,000 points (2,000×2 seconds left+2000 bonus points). In addition, anytime the user tops his personal best in any leaderboard category or tops an all-time finest score, notification would occur on the game board with the appropriate sound effects. The scoreboard will reflect the run(s) and point(s). In this case, it is the first inning; the user has had a home run with no players on base for one run and has received 6000 points. The user begins again by clicking the “Pitch” button for his second batter up.

After three innings, the game ends, the pitch icon disappears and the scoreboard reflects the final score. The user's stats are finalized. If the user wants to play the same game again, he would select “Play Again.” If the user was playing Vintage Stars & HOFers and wants to play a different game, i.e. Vintage All Cards, Modern Stars & HOFers, or Modern All Cards, he would go Home and select another game.

If a user wants to challenge a friend to top his score, he would click the “Challenge” button 2310 on the user interface 2300. His challenge and stats 2320 would be sent to the friend whose contact information he enters into the box 2330, as shown in FIG. 23. The user's friend would receive an email which would link to the same gave level as challenged, in this case “Vintage HOFers & All Stars.”

Stats are linked from the menu bar and will display the Leader Board for all users by their screen names. If the user is logged in, his stats will be viewable and will be compared to the leader's stats. If the user is a leader in a category, his stats should be highlighted. If he clicks on any category he should be able to see a list of the stats in order for the top 10, 25, 50, 100 users and see where he ranks within the group. Additionally, the final stats for each season should be saved and linked from this page. This will also highlight the MVP for the year.

If the user is not logged in, his own stats will not be viewable unless he qualifies for the Leader Board. If he clicks on any category he should be able to see the stats in order the top 10, 25, 50, 100 users.

The following stats will be recorded:
Most runs in a game
Most runs in a season
Most runs lifetime
Most hits in a game
Most hits in a season
Most hits lifetime
Most home runs in a game
Most home runs in a season
Most home runs lifetime
Most grand slams in a game
Most grand slams in a season
Most grand slams lifetime
Batting avg in a game (the total number of hits divided by the total number of At Bats)
Batting avg in a season
Batting avg lifetime
Slugging % in a game ((1B)+(2×2B)+(3×3B)+(4×HR)) divided by number of At

### Bats

Slugging % in a season
Slugging % lifetime
Most accumulated points:
Most points in a game
Most points in a season
Most points lifetime

### Most Valuable Player of the Year:

The user who has the most #1 stats at the end of a season will be recognized as the Most Valuable Player of the Year.

Prizes will be highlighted on the Prizes page with a horizontal slide show. In addition, a complete listing of prizes will be available to view. This page should be provided with administration so that it can be updated by game managers.

Thus, specific embodiments and methods of sports collectibles and commodities games have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A sports collectibles and commodities game, comprising:
at least one generated image of a collectible item, wherein the generated image comprises an area that is strategically incomplete;
an interface that allows a player to describe, supplement or complete the image and allows a player to access a resource database, and
a resource database that includes at least one fact about the collectible item, at least one piece of trivia about the collectible item, at least one famous owner of the collectible item or a combination thereof.

2. The game of claim 1, further comprising a timing mechanism that is coupled to the generated image.

3. The game of claim 1, wherein the timing mechanism comprises at least one timed event.

4. The game of claim 1, wherein the at least one timed event comprises a repeating countdown.

5. The game of claim 1, further comprising a scoring system.

6. The game of claim 1, wherein the scoring system is operatively coupled with the timing mechanism.

7. The game of claim 1, wherein the scoring system comprises scoring points, earning currency, advancing around a series of bases, gaining at least one yard or a combination thereof.

8. The game of claim 1, wherein the collectible item comprises a coin, a paper currency, a trading card, a motorized vehicle or a combination thereof.

9. The game of claim 8, wherein the trading card comprises a sports trading card.

10. The game of claim 1, wherein the interface comprises a keyboard, a touchscreen, a voice-activated system, a voice-digitalization system or a combination thereof.

11. The game of claim 1, wherein the resource database further comprises completed information for the collectible items.

12. The game of claim 1, wherein the interface further comprises an interactive component.

13. The game of claim 12, wherein the interactive component operatively allows more than one player to actively participate in the game.

14. The game of claim 1, wherein the interactive component comprises at least one social media login component, at least one social media sharing component or a combination thereof.

15. The game of claim 13, wherein the interactive component comprises a league component, a random challenge component or a combination thereof.

16-17. (canceled)
